(19) United States
(12) Patent Application Publication
(10) Pub. No.: US 2017/0254446 A1
(43) Pub. Date: Sep. 7, 2017

(54) UNBONDED FLEXIBLE PIPE

(71) Applicant: National Oilwell Varco Denmark I/S, Brøndby (DK)

(72) Inventor: Kristian Glejbøl, Glostrup (DK)

(21) Appl. No.: 15/504,892

(22) PCT Filed: Aug. 31, 2015
(86) PCT No.: PCT/DK2015/050255

§ 371 Date: Feb. 17, 2017

(30) Foreign Application Priority Data
Sep. 2, 2014 (DK) PA 2014 70531

(51) Int. Cl. F16L 11/08; B32B 1/08; B32B 3/26; B32B 7/12; B32B 27/08; B32B 9/04; B32B 15/08; B32B 15/18; B32B 15/20; F16L 58/00; B32B 9/00

(52) U.S. Cl. CPC F16L 11/083; F16L 58/00; B32B 1/08; B32B 3/266; B32B 7/12; B32B 9/005; B32B 9/045; B32B 15/08; B32B 15/18; B32B 15/20; B32B 27/08; B32B 2307/554; B32B 2307/714; B32B 2307/7265; B32B 2597/00

(57) ABSTRACT

The present invention relates to an unbonded flexible pipe including a bore for transport of a fluid wherein the unbonded flexible pipe includes an internal pressure structure including a fluid-tight polymer sheath and a barrier layer on the inside of the fluid-tight polymer sheath and bonded thereto, wherein the internal pressure sheath further includes a permeable protection sheath inside the fluid-tight polymer sheath and, wherein the barrier layer is located between the fluid-tight polymer sheath and the permeable protection sheath.

### TECHNICAL FIELD

The present invention relates to an unbonded flexible pipe comprising a bore for transport of a fluid wherein said unbonded flexible pipe comprises an internal pressure structure comprising sub-layers.

### BACKGROUND

Unbonded flexible pipes are frequently used as flexible risers or flexible flowlines for transport of fluid hydrocarbons such as oil and gas.

Moreover, unbonded flexible pipes are often used e.g. as riser pipes or flowlines in the production of oil or other subsea applications.

The unbonded flexible pipes are constructed of a number of independent layers, such as helically laid steel and polymeric layers formed around a central bore for transporting fluids. A typical unbonded flexible pipe comprises from the inside and outwards an inner armoring layer known as the carcass, an internal pressure sheath surrounded by one or more armoring layers, such as pressure armoring and tensile armoring, and an outer sheath. Thus, the internal pressure sheath forms a bore in which the fluid to be transported is conveyed. In some unbonded flexible pipes the carcass may be omitted and when the carcass is omitted the bore is denoted a smooth bore. When the carcass is present, the bore is denoted a rough bore. The annular space between the internal pressure sheath and the outer sheath is known as the annulus and houses the pressure armoring and the tensile armoring.

The unbonded flexible pipes may carry the fluids between a hydrocarbon reservoir located under the sea bed and a floating structure. The fluid may be a hydrocarbon fluid, such as natural gas or oil, depending upon the nature of the hydrocarbon reservoir, or an injection fluid such as water. The fluids, which are transported to the floating structure, can be processed for example by compression and/or further treatment. When the floating structure is moored close to a gas field or hydrocarbon reservoir, it can be kept in fluid communication with the producing well heads via one or more flexible risers. The one or more flexible risers can convey fluids between the well heads of a hydrocarbon reservoir and the floating structure. Flexible risers can be configured as free-hanging catenaries or provided in alternative configurations, such as lazy wave and lazy S types, using buoyancy modules.

Thus, a flexible riser can be connected at one end to the floating structure, and at another end to a riser base manifold, which secure the flexible riser to the sea bed.

Flexible unbonded pipes of the present type are for example described in the standard “Recommended Practice for Flexible Pipe”, ANSI/API 17 B, fourth Edition, July 2008, and the standard “Specification for Unbonded Flexible Pipe”, ANSI/API 17J, Third edition, July 2008. As mentioned such pipes usually comprise an innermost sealing sheath—often referred to as an internal pressure sheath, which forms a barrier against the outflow of the fluid which is conveyed in the bore of the pipe, and one or usually a plurality of armoring layers. Normally the pipe further comprises an outer protection layer, often referred to as the outer sheath, which provides mechanical protection of the armor layers. The outer protection layer may be a sealing layer sealing against ingress of sea water. In certain unbonded flexible pipes one or more intermediate sealing layers are arranged between armor layers.

In general flexible pipes are expected to have a lifetime of 20 years in operation or more.

The term “unbonded” means in this text that at least two of the layers including the armoring layers and polymer layers are not bonded to each other. In practice the known pipe normally comprises at least two armoring layers located outside the internal pressure sheath and optionally an armor structure located inside the internal pressure sheath, which inner armor structure normally is referred to as the carcass.

The armoring layers comprise or consist of multiple elongated armoring elements that are not bonded to each other directly or indirectly via other layers along the pipe. Thereby the pipe becomes bendable and sufficiently flexible to roll up for transportation.

The internal pressure sheath which is sometimes also referred to as an inner liner forms a tubular structure with a bore in which fluid is convoyed. As the fluid is oil and natural gas, which by nature comprises plenty of gaseous substances such as CO₂ and H₂S, the liner needs to be substantially impermeable to gases. When producing inner liners for unbonded flexible pipes it is a well-known fact that the liner has to be produced without internal voids. During use the pipes sometimes are rapidly decompressed. If gas has diffused into these voids, the rapid decompression event may destroy the liner due to a violent expansion of the gas filled voids.

Also if gas has diffused to the space outside the liner, rapid decompression of the pipe core may cause the liner to implode, thereby destroying the pipe.

Moreover, in a conventional internal pressure sheath made from a polymer material the gases, such as CO₂ and H₂S, may pass through the polymer material by diffusion and into the annulus formed between the internal pressure sheath and the outer sheath of the flexible pipe. In this annulus the armor layers are present and the diffusing gases may cause corrosion of the armoring layers which are made from metallic material. Such corrosion is highly undesired as it may lead to a breakdown of the pipe and requires a replacement of the pipe.

European patent no. EP 1 663 637 B1 and U.S. Pat. No. 4,903,735 disclose solutions in which the diffusion of gases through the internal pressure sheath is limited by use of a membrane layer.

### DISCLOSURE OF INVENTION

An object of the present invention is to provide an unbonded flexible pipe, in which corrosion of armor layers in the annulus of the pipe is relatively low and which at the same time has an internal pressure sheath which has a high resistance towards wear.

Thus, the present invention aims at alleviating problems caused by gases in the fluid convoyed in the unbonded flexible pipes, where excessive amounts of gases may pass through the internal pressure sheath by diffusion and get in contact with the metallic armor layers surrounding the internal pressure sheath, and thereby cause corrosion in the armor layers.

These and other objects have been solved by the invention or embodiments thereof as defined in the claims and as described herein below.

It has been found that the invention or embodiments thereof have a number of additional advantages which will be clear to the skilled person from the following description.

Consequently, the present invention relates to an unbonded flexible pipe having a longitudinal axis and a bore for transport of a fluid, said unbonded flexible pipe comprises one or more external armouring layers wound around an internal pressure structure defining the bore, said internal pressure structure comprises from the inside and out a permeable protection sheath, a barrier layer and a fluid-tight polymer sheath, wherein the barrier layer is bonded to the fluid-tight polymer sheath.

In this context the bore is considered to be substantially symmetrical around the axis of the pipe. The axis or center axis of the pipe is coincident with the longitudinal axis of the pipe and the terms “axis”, “center axis” and “longitudinal axis” may be used interchangeably.

The term “substantially” should herein be taken to mean that ordinary product variances and tolerances are comprised.

The term “inside” of a layer is the side of the layer facing the axis of the pipe. The term “outer side” of a layer is the side of the layer facing away from the axis of the pipe. In a similar manner the terms “inner layer” and “outer layer” mean the inner layer is closer to the axis of the pipe than the outer layer. The terms “inner surface” and “outer surface” mean the inner surface is closer to the axis of the pipe than the outer surface.

The internal pressure structure in the unbonded flexible pipe according to the present invention corresponds to the internal pressure sheath in a conventional unbonded flexible pipe.

A conventional unbonded flexible pipe always comprises an internal pressure sheath, which forms the bore in which the fluid to be transported is conveyed; sometimes the internal pressure sheath may be reinforced with a carcass. Thus, the internal pressure sheath is substantially fluid tight, meaning that no liquids or gases should be able to pass through the internal pressure sheath. However, as the internal pressure sheath frequently comprises a polymer material, such as polyethylene or polyvinylidene diflouride, through which gases during time are able to pass through by diffusion, the internal pressure sheath may not be entirely gas tight. The diffusing gasses may be vapor (H₂O), methane (CH₄), carbon dioxide (CO₂) and hydrogen sulfide (H₂S), and if the gases diffuse through the internal pressure sheath, they may cause the armor layers in the annulus between the internal pressure sheath and the outer sheath to corrode.

The internal pressure sheath may be a single layer or consist of a number of sub-layers. In the present invention the internal pressure structure comprises at least three layers or sub-layers. From the inside of the pipe and outwards the at least three layers are a permeable or non-fluid-tight layer also referred to as the permeable protection layer or the permeable protection sheath, a barrier layer and a fluid-tight polymer layer also referred to as the fluid-tight polymer sheath. In an embodiment the internal pressure structure may comprise more layers than the barrier layer between the permeable layer and the fluid-tight layer.

The fluid-tight polymer layer is a part of the internal pressure structure, and in is respect of the axis of the pipe it is the outer layer in the internal pressure structure. The fluid-tight polymer layer is substantially fluid tight. However, although the fluid-tight polymer layer is substantially fluid tight, gases or molecules of gases may be able to diffuse through the fluid-tight polymer layer over a period of time as described above. Thus, the fluid-tight polymer layer does not entirely prevent gases from diffusing through the layer. The amount of gas which is able to diffuse through a polymer layer may be expressed by means of the permeability coefficient (Pe′) expressed in (g cm)/(cm² s). The permeability coefficient of a polymer layer at a certain temperature may be determined by the method described in “High pressure permeation of gases in semicrystalline polymers: Measurement method and experimental data; B. Flaconneche et al; In 3^{rd} MERL Conference on Oilfield Engineering with Polymers; 28-29 Nov. 2001; London UK.

The barrier layer, which is also a part of the internal pressure structure, serves to form a barrier for gases, i.e. inhibits or prevents the gases from diffusing through at least a part of the fluid-tight polymer sheath. The barrier layer is a layer which has a permeability coefficient which is at least 10 times lower than the permeability coefficient of the fluid-tight layer.

In an embodiment the barrier layer is a polymer and the permeability coefficient of the barrier layer is at least 10 times lower than the permeability coefficient of the fluid-tight layer. Preferably the permeability coefficient of the barrier layer is at least 20 times lower than the permeability coefficient of the fluid-tight layer, suitably the permeability coefficient of the barrier layer is at least 50 times lower than the permeability coefficient of the fluid-tight layer, conveniently the permeability coefficient of the barrier layer is at least 100 times lower than the permeability coefficient of the fluid-tight layer.

In an embodiment the barrier layer is a metal layer and this barrier layer is gas tight and will not allow gases to pass through, even by diffusion.

The barrier layer may be applied to the entire inner surface of the fluid-tight polymer layer, or the barrier layer may be applied to only a part of the inner surface of the fluid-tight polymer layer. In an embodiment where the barrier layer only covers a part of the fluid-tight polymer layer, gases may diffuse through the non-covered parts or the fluid-tight polymer layer without the inhibiting effect of the barrier layer. In an embodiment where the barrier layer is applied as a tape with windings, there will normally be space between the windings through which gases may pass. However, such an applied barrier layer will reduce the amount of gas molecules which may diffuse through the fluid-tight sheath. The amount of gas diffusing through the fluid-tight sheath may e.g. be reduced to about half compared to a fluid-tight sheath without the barrier layer. The amount of diffusing gases may be measured in weight unit per time unit or volume unit per time unit.

The permeable protection layer is also a layer in the internal pressure structure. The permeable protection layer is not fluid tight and will allow at least gases to pass through the layer. In an embodiment the permeable protection layer has a permeability coefficient which is at least 10 times higher than the permeability coefficient of the fluid-tight layer. Preferably the permeability coefficient of the permeable protection layer is at least 20 times higher than the permeability coefficient of the fluid-tight layer, suitably the permeability coefficient of the permeable protection layer is at least 50 times higher than the permeability coefficient of the fluid-tight layer, conveniently the permeability coefficient of the permeable protection layer is at least 100 times higher than the permeability coefficient of the fluid-tight layer.

The permeable protection layer may be considered to be a vented polymer layer. One function of the permeable protection layer is to serve as a mechanical protection, e.g. to protect the barrier layer and the fluid-tight polymer sheath against wear and abrasion e.g. caused by particles, such as sand or small stones in the fluid which is conveyed in the bore of the pipe. Moreover, if the unbonded flexible pipe comprises a carcass, the permeable protection layer may protect the barrier layer and the fluid-tight sheath from damage caused by the carcass.

Thus, in an embodiment the unbonded flexible pipe comprising a bore for transport of a fluid according to the invention comprises an internal pressure sheath comprising a fluid-tight polymer sheath and a permeable protection sheath inside the fluid-tight polymer sheath, where a barrier layer is located between the fluid-tight polymer sheath and the permeable protection sheath. In an embodiment the barrier layer is bonded to the inner surface of the fluid-tight polymer sheath.

The fluid-tight polymer sheath forming a part of the internal pressure sheath is advantageously made from an extruded polymer material, such as polyamide, polyvinylidene diflouride or polyethylene, e.g. high density polyethylene or cross linked polyethylene. Examples of useful polymers for the fluid-tight polymer sheath may include the following: polyolefins, such as polyethylene and poly propylene; polyamide, such as poly amide-imide, polyamide-11 (PA-11) and polyamide-12 (PA-12); polyimide (PI); polyurethanes; polyureas; polyesters; polyacetals; polyethers, such as polyether sulphone (PES); polyoxides; polysulfides, such as polyphenylene sulphide (PPS); polysulphones, such as polyarylsulphone (PAS); polyacrylates; and polyethylene terephthalate (PET).

The thickness of the fluid-tight polymer sheath is preferably in the range of about 4 to about 25 mm. A sheath which is too thin may have too low mechanical strength, whereas a too thick fluid-tight polymer sheath may result in a reduced flexibility of the final unbonded flexible pipe. In general, it is thus desired that the fluid-tight polymer sheath has a thickness of at least 4 mm, such as at least 6 mm, such as at least 8 mm, such as at least 10 mm, such as at least 12 mm, and preferably the fluid-tight polymer sheath has a thickness between 4 and 20 mm, such as between 8 and 15 mm.

As mentioned, the fluid-tight polymer sheath is substantially impermeable to fluids, however, it may be possible for gases such as H₂O, CO₂ and H₂5 to diffuse though the polymer material. The fluid-tight polymer sheath is preferably extruded and has a tubular shape, which has an inner surface and an outer surface. The outer surface is surrounded by one or more armoring layers, such as pressure armoring and tensile armoring. In an embodiment the inner surface of the fluid-tight sheath is in contact with the barrier layer, which with the opposing surface is in contact with the permeable protection sheath.

The permeable protection sheath may be based on polymers, such as polyethylene, polypropylene, polyamide, or polyvinylidene diflouride. The useful polymers may be the same as the polymers useful for the fluid-tight polymer sheath. The permeable protection sheath may be extruded or wound from tapes or strips to form a tubular structure. In an embodiment of the unbonded flexible pipe the permeable protection sheath is in direct contact with the fluid to be transported.

When a gas containing fluid is transported in the unbonded flexible pipe it has been found that the barrier layer bonded to the inner surface of the fluid-tight polymer sheath will serve to alleviate problems with gases, such as CO₂ and H₂S which diffuse though the polymer material.

The thickness of the permeable protection sheath is preferably in the range of 1 to 25 mm such as in the range of 4 to 25 mm. The permeable protection sheath may be very thin, e.g. in the range of 0.1 to 1 mm, however, it is preferred that the zo permeable protection sheath has a certain thickness, as a very thin sheath may have a too low mechanical strength, whereas a too thick permeable protection sheath may result in a reduced flexibility of the final unbonded flexible pipe. In general, it is thus desired that the permeable protection sheath has a thickness of at least 4 mm, such as at least 6 mm, such as at least 8 mm, such as at least 10 mm, such as at least 12 mm, and preferably the permeable protection sheath has a thickness between 4 and 20 mm, such as between 5 and 10 mm.

The barrier layer is made from a metal or metal alloy or polymer which is able to withstand the effect of corrosive substances in the fluid conveyed in the bore of the unbonded flexible pipe and has a permeability coefficient which is at least 10 times lower than the permeability coefficient of the fluid-tight layer.

The barrier layer may in principle be a film or foil of a suitable material, preferably with a thickness e.g. less than 4 mm. Thus, the barrier layer may e.g. have a thickness of about 25 μm or more, such as about 100 μm or more, such as about 500 μm or more, such as about 1 mm or less.

Useful materials for the barrier layer include inter alia materials of the group consisting of polymer, metal, ceramic, glass, metal containing compositions and combinations thereof.

Useful polymer materials for the barrier layer include inter alia polymer film comprising one or more of the polymer materials selected from the group consisting of polyolefins, such as polyethylene and poly propylene; polyamide, such as poly amide-imide, polyamide-11 (PA-11), polyamide-12 (PA-12) and polyamide-6 (PA-6); polyimide (PI); polyurethanes; polyureas; polyesters; polyacetals; polyethers, such as polyether sulphone (PES); polyoxides; polysulfides, such as polyphenylene sulphide (PPS); polysulphones, such as polyarylsulphone (PAS); polyacrylates; is polyethylene terephthalate (PET); polyether-ether-ketones (PEEK); polyvinyls; polyacrylonitrils; polyetherketoneketone (PEKK); and lymers of the preceding; fluorous polymers such as polyvinylidene diflouride (PVDF), homopolymers and copolymers of vinylidene fluoride (“VF2”), homopolymers and copolymers of trifluoroethylene (“VF3”), copolymers and terpolymers comprising two or more different members selected from the group consisting of VF2, VF3, chlorotrifluoroethylene, tetrafluoroethylene, hexafluoropropene, and hexafluoroethylene.

In an embodiment, the barrier layer is made from metal e.g. in the form of a metal film or foil such as a film or foil comprising or consisting of aluminum, stainless steel, titanium, or gold.

In an embodiment, the barrier layer is a layered material. The layered barrier layer may e.g. be composed of a metal layer and a primer layer, wherein the primer preferably may be a layer comprising C atoms.

In an embodiment, the layered barrier layer comprises at least one metal layer, such as two, such as three metal layers. The barrier layer may optionally comprise one or more polymeric layers.

In an embodiment, the barrier layer may comprise metal containing compositions, such as metal oxides and metal halides. When using such materials the barrier layer should preferably be a layered material so that the metal oxides and metal halides are protected from contact with corrosive fluids.

The barrier layer may in an embodiment be a mixture of polymer with carbon and/or metal and/or metal containing particles. The barrier layer may also be a polymer film containing at least one layer of a high barrier forming polymer material such as polyparylene.

In an embodiment the barrier layer is bonded to the inner surface of the fluid-tight polymer sheath by means of a physical and/or chemical bonding. Thus, in an embodiment the barrier layer is bonded to the inner surface of the fluid-tight polymer sheath by gluing using an adhesive. Alternatively, the barrier layer may be bonded to the inner surface of the inner sealing sheath by a chemical reaction between the barrier layer and the material of the fluid-tight polymer sheath. Yet another possibility is to coat a metal film with a polymer which is compatible with the material of the fluid-tight sheath. Thus, the polymer coating and the fluid-tight polymer sheath may fuse together when the coated film is covered with the fluid-tight polymer sheath, e.g. when the fluid-tight sheath is extruded.

Both a physical and chemical bonding will provide a good adhesion between the barrier layer and the inner surface of the fluid-tight polymer sheath.

In an embodiment of the barrier layer it is convenient that the barrier layer is bonded either to the fluid-tight polymer sheath and/or to itself with its entire surface facing the fluid-tight polymer sheath, i.e. the surface of the barrier layer facing the fluid-tight polymer sheath is bonded to the fluid-tight polymer sheath in its entire extension. Thus, such a bonding is a coherent bonding and not a pointwise bonding. The coherent bonding is an interface bonding between two surfaces in which all contacting surfaces are bonded.

In an embodiment, preferably at least the edges of the barrier layer are bonded to themselves or to the fluid-tight polymer sheath. This embodiment can be realized when the barrier layer is applied as a wound tape or an elongate strip. The edges of the tape or elongate strip may then be bonded to themselves, e.g. when the windings are overlapping, and/or bonded to the fluid-tight polymer sheath.

In one embodiment, the fluid-tight polymer layer is bonded to the barrier layer via one or more bonds from the group of physical bonding and chemical bonding, such as ion bonding and covalent bonding or intermixing.

The bonding property may be measured by a peel test for tearing the barrier layer and the fluid-tight polymer sheath from each other, e.g. using ASTM D3330.

Preferable the bonding has a peel strength using ASTM D3330 of at least 300 N/m, such as at least 500 N/m, such as at least 700 N/m.

In an embodiment, where the barrier layer in itself is a layered material, e.g. of two, three or four individual polymer, metal or other layers, all interface bondings including bondings between layers of the barrier layer and bondings between the fluid-tight polymer sheath and the barrier layer, are stronger than the internal bondings in the fluid-tight polymer sheath and the barrier layer. The individual layers may e.g. be glued or pressed together, or the bonding may be obtained by subjecting the fluid-tight polymer sheath to heat to softening or even melting point. As another alternative the individual layers may be sprayed or brushed e.g. in the form of a solution or dispersion in a solvent, which solvent afterwards is allowed to evaporate.

Although the barrier layer may comprise more layers, it will appear and function as a barrier layer as if it was a single layer.

In an embodiment, the interface bonding(s) between the one or more layers, barrier layer and fluid-tight polymer sheath, is/are stronger than the internal bonding of the fluid-tight polymer sheath. The interface bonding is a coherent bonding and is a bonding between two surfaces in which all contacting surfaces are bonded

The bonding between the fluid-tight polymer sheath and the barrier layer may e.g. be sufficiently strong to prevent creation of gas pockets between the layers when subjected to an increased pressure on the barrier layer side of the pipe, where the pressure is 5 bar, 10 bars 50, bars or even 100 bars or higher, and where the gas comprises at least 10% by vol. of methane, at least 10% by vol. of hydrogen sulphide, and at least 10% by vol. of carbon dioxide.

In an embodiment, it is desired that the barrier layer or at least the surface of the barrier layer that is facing the fluid-tight polymer sheath comprises C atoms. Thereby an improved adhesion between the barrier layer and the fluid-tight polymer sheath is obtained, in particular if the fluid-tight polymer sheath is subjected to a cross-linking step after being applied face to face with the barrier layer, because this cross-linking step provides covalent bondings between the fluid-tight polymer sheath and the C atoms of the barrier layer.

In an embodiment, the surface of the barrier layer facing the fluid-tight polymer sheath comprises a primer. This primer may in principle be any type of primer that facilitates a satisfactory bonding between the fluid-tight polymer sheath and the barrier layer. The primer may e.g. be a C atom containing primer.

Thus, in an embodiment the barrier layer or the barrier layer with a primer comprises C atoms, and the fluid-tight polymer sheath is a cross-linked polymer with bondings linking to the C atoms of the film.

The optimal primer depends largely on the film layer material. Examples of useful primers include latex primers (UCAR™ Latex by DOW. Latex Metal Primer—DTM by Hytech), epoxy primers (EP420 PRIMER GREEN by AEROCENTER AIRCRAFT SUPPLY and AVIONICS), ascrylat/methacrulat primers, Rusty Metal Primer by Rustoleum,

Metal-Prime by Hytech, Anti-rust primer by Plascon International Ltd, MPI #23 Surface Tolerant Metal Primer by Bennette paint, Samhwa paint. The primers may be based on amines, silanes or peroxides.

The primer may for example be applied by spraying gluing and/or pressing. Alternatively the primer may be a plasma deposited layer.

When the barrier layer is glued to the inner surface of the fluid-tight polymer sheath, the adhesive may be a resin e.g. based on epoxy or polyurethane. In case the barrier layer is bonded to the fluid-tight polymer sheath by a chemical reaction, this reaction may be initiated by a heat treatment, e.g. by using a laser.

For maintaining a high flexibility while having a low gas permeability, it is desired that the fluid-tight polymer sheath is thicker than barrier layer, such as 4 times as thick or more, such as 10 times as thick or more such as 10 times as thick or more, such as 50 times as thick or more, such as up to 100 times as thick.

In an embodiment the barrier layer does not cover the entire inner surface of the fluid-tight polymer sheath. Thus, in these embodiments the barrier layer at least covers a part of the inner surface of the fluid tight polymer sheath, and preferably the barrier layer covers at least 50%, more preferred at least 75%, even more preferred at least 90% of the inner surface of the fluid-tight polymer sheath. Although a solution, by which the inner surface of the fluid-tight polymer sheath is not entirely covered by a barrier layer, does not entirely prevent gases from the fluid in the bore from diffusing through the fluid-tight polymer sheath, it will, however, reduce the amount of gases diffusing through the fluid-tight sealing sheath. This reduced diffusion of gases may be sufficient to reduce the corrosion of the armor layers in the annulus to a level by which the armor layers will remain functional during the life time of the unbonded flexible pipe.

During use parts of the pipe are subjected to heavy continuous bending. In these parts of the pipe the barrier properties of the barrier layer in the internal pressure sheath may be impaired over time. This is, however, acceptable since the total influx of gasses to the annulus is still reduced significantly compared to a pipe without a barrier layer.

The barrier layer can be an extruded layer, e.g. extruded onto the permeable protection sheath, where after the fluid-tight polymer sheath can be extruded onto the barrier layer and bonded thereto. Alternatively, the barrier layer can be in the form of an elongate strip or tape, and in the unbonded flexible pipe the elongate strip or tape is wound with windings to form a tubular structure. The tubular structure will be the barrier layer which covers the inner surface of the fluid-tight polymer sheath and which is bonded thereto.

Thus, in an embodiment the barrier layer is in the form of a tape wound to a tubular structure, where the term “tape” includes thin films of 1 mm or less and with a width of up to 10 cm.

The tape can be wound with an inclination in respect of the axis of the unbonded flexible pipe in the range of from about 75° to about 89.8°, such as from about 85° to about 88°.

The barrier layer may be wound from the elongate strips or tape to form a tubular structure of consecutive windings, in which there is an overlap between adjacent windings. The overlap between adjacent windings may be sealed, e.g. with a resin, and thus forms a substantially diffusion tight barrier.

As mentioned, in an embodiment the barrier layer may not entirely cover the inner surface of the fluid-tight polymer sheath and when the barrier layer is applied as elongate strips or tapes to the inner surface of the fluid-tight sheath, there may be a distance d between the adjacent windings. This means that a gap is provided between adjacent windings and between these gaps the inner surface of the fluid-tight polymer sheath is exposed. To minimize the amount of gases that may diffuse through the fluid-tight polymer sheath where it is exposed, the width d of the gap is advantageously less than the thickness of the fluid-tight polymer sheath and preferably the width d should be less than ⅓ the thickness of the fluid-tight polymer sheath. The width d of the gap is significantly smaller than the width D of the metal strip forming the metal layer, and d is preferably within the range 0.001D to 0.1D. Thus, if the width D of the metal strip is 10 cm, then the width d of the gap is in the range between 0.01 cm to 1.0 cm.

Although the barrier layer may be a metal plate or metal strip, the metal layer can conveniently be a metal foil. A metal foil is rather thin and easy to handle during production of the unbonded flexible pipe. Moreover, a metal foil will have satisfactory barrier properties in respect of gases. A metal foil can be applied to the inner surface of the fluid-tight polymer sheath as a strip or tape.

Although it is possible to apply a barrier layer which comprises two or more layers, e.g. obtained from a folded metal plate, the barrier layer according to the invention is preferably a single layer. A single layer is easy to handle and apply during production and a single barrier layer will have the properties to provide a sufficient barrier for gases. A single barrier layer as described above may comprise sub-layers which are adhered to each other in one step, and thus appears and functions as a single layer.

Contrary to the barrier layer, the permeable protection sheath is not intended to serve as a barrier for gases. The primary function of the permeable protection sheath is to serve as a mechanical protection. However, the permeable protection sheath may at least to a certain degree absorb and store gases, e.g. in voids or pores in the material of the permeable protection sheath, which will serve to regulate the gas pressure in the fluid which is transported in the pipe. Thus, in an embodiment the permeable protection sheath is porous. The porous sheath will allow gases to penetrate all the way through the permeable protection sheath, and also be able to store an amount of gas inside the permeable protection sheath.

In an alternative embodiment the permeable protection sheath comprises holes. The holes will go through the permeable protection sheath and allow gases to pass through the sheath. As the polymer in the permeable protection sheath may flow, e.g. in response to pressure and/or shear, the polymer may in some occasions flow as a viscous fluid in such a way that it will close the holes. Thus, in an embodiment the holes in the permeable protection sheath are reinforced. The reinforcement may e.g. be metal rings or bushes which are inserted in the holes to ensure they remain open.

The holes may have a cylindrical shape and have a diameter in the range of about 0.5 mm to about 5 mm. The holes may be formed in the permeable protection sheath as a regular pattern with a distance between the holes in the longitudinal direction of the pipe of about 5 to 101 cm, such as about 5 to 252 cm or 5 to 503 cm or even 5 to 1004 cm. The longitudinal direction is a direction which is parallel to the axis of the pipe.

When gases pass through the permeable protection sheath, the gases will eventually meet the barrier layer which forms a relatively impermeable barrier for the gases, i.e. the barrier layer has a permeability coefficient which is at least 10 times lower than the permeability coefficient of the fluid-tight layer. As the permeable protection sheath is not bonded to the barrier layer, the gases accumulate in the boundary or interface between the barrier layer and the permeable protection sheath and form pockets of gas. This may happen if the gas pressure in the fluid transported in the unbonded flexible pipe is high. However, if the pressure drops in the fluid to be transported, the gas in the permeable protection sheath is released and serve to balance the gas pressure in the fluid.

As the permeable protection sheath is not bonded to the barrier layer it is possible that longitudinal displacements, i.e. displacements in the axial direction of the pipe, may appear between the barrier layer and the permeable protection sheath. Thus, in an embodiment the permeable protection sheath in the surface facing the barrier layer comprises one or more indentations. The indentations serve as “locks” for the permeable protection sheath, i.e. when the fluid-tight polymer sheath is applied during the production of the unbonded flexible pipe, the fluid-tight polymer sheath will create a pressure which will force a part of the barrier layer and a part of the fluid-tight polymer layer into the indentations in the permeable protection sheath and in this manner “lock” the permeable protection sheath in respect of the barrier layer. The indentations may be in the form of recesses, dents or grooves in the surface of the permeable protection sheath and may be distributed in a regular pattern along the outer surface of the permeable protection sheath. The indentations may for example be provided in the form of annular grooves around the outer surface of the permeable protection sheath. The annular grooves may be provided with a distance of about 20 to 100 cm along the permeable protection sheath.

The unbonded flexible pipe may also comprise a carcass. The carcass is an armor layer in the bore of the pipe, which prevents the inner sealing sheath from collapsing in case of a pressure drop in the fluid transported in the unbonded flexible pipe and also serves to resist hydrostatic forces. In an embodiment the inner side of the carcass will be in contact with the transported fluid and on the outer side the carcass will be in contact with the permeable sheath.

Besides a carcass the unbonded flexible pipe also comprises one or more external armouring layers surrounding the fluid-tight polymer sheath, i.e. the external armouring layers are placed on the outer side of the fluid-tight polymer sheath, and, thus, the internal pressure structure. The armouring layers may be pressure armour layers and/or tensile armour layers.

Thus, the unbonded flexible pipe may comprise one or more pressure armour layers, such layers are typically made from elongate members wound with an angle of approximately 65° to about 89.5° in respect of the center axis. Frequently an unbonded flexible pipe comprises two pressure armour layers which are wound either in the same or in opposite directions in respect of the center axis.

The unbonded flexible pipe may also comprise one or more tensile armour layers. Very often an unbonded flexible pipe comprises two tensile armour layers which are wound in opposite directions in respect of the center axis. The winding angle in respect of the center axis is approximately in the range of 25° to 55°.

Moreover, the unbonded flexible pipe may comprise an outer protective sheath, which may be permeable or impermeable to fluid. In case the external armouring layers are made from metallic material it is advantageous that the outer protective sheath is made from a material which is impermeable to fluid, such that the ingress of e.g. seawater to the metallic armouring layers is avoided. The outer protective sheath may e.g. be made from extruded high density polyethylene (HDPE) or polyvinylidene diflouride (PVDF).

### DETAILED DESCRIPTION OF THE INVENTION

The invention will now be described in further details with reference to the drawings in which:

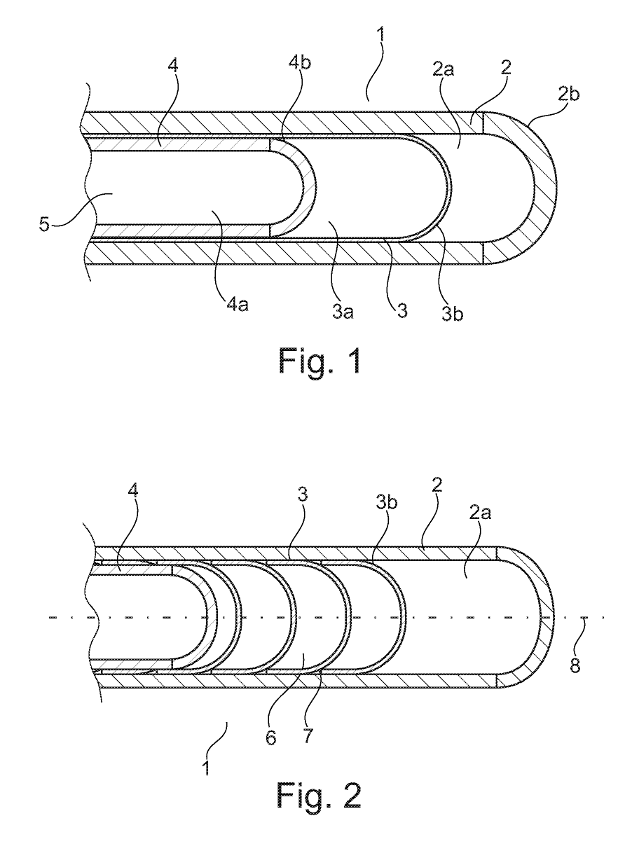

FIG. 1 shows an embodiment according to the invention;

FIG. 2 shows an alternative embodiment according to the invention;

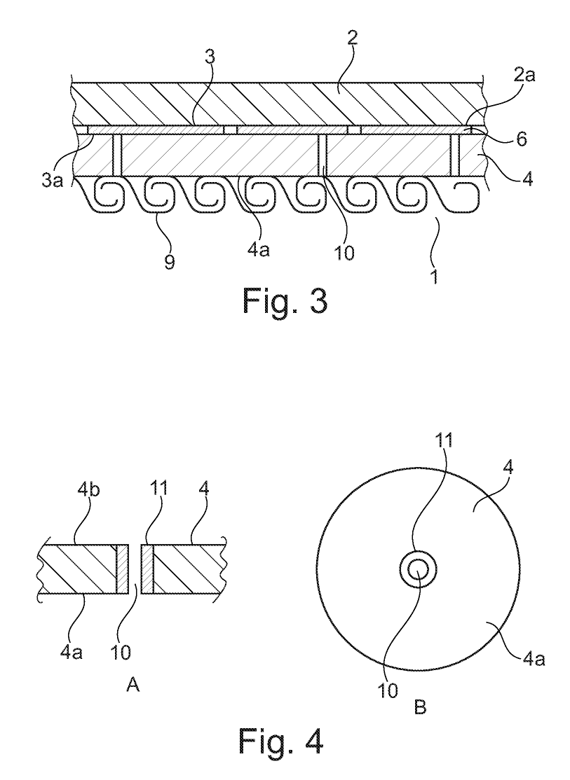

FIG. 3 shows details of the layers according to the invention;

FIG. 4 shows further details; and

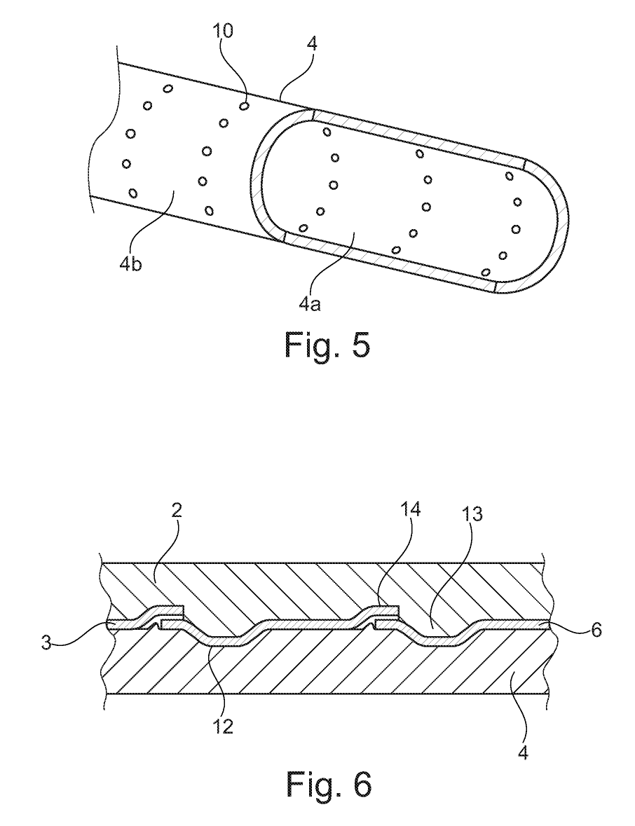

FIG. 5 shows a permeable protection sheath with holes; and

FIG. 6 shows a permeable protection sheath with indentations.

The drawings are only intended to illustrate the principles of the invention and are schematical depictions. Details of the unbonded flexible pipe which are not part of the invention have been omitted. In the drawings the same reference numbers are used for the same parts.

FIG. 1 shows an internal pressure sheath 1 with sub-layers for an unbonded flexible pipe. The internal pressure sheath 1 comprises a fluid-tight sheath 2, a barrier layer 3 and a permeable protection sheath 4. The barrier layer 3 is with the outer surface 3b bonded to the inner surface 2a of the fluid-tight polymer sheath 2. However, the inner surface 3a of the barrier layer 3 is not bonded to the outer surface 4b of the permeable protection sheath 4. The inner surface 4a of the permeable protection sheath 4 forms a bore 5, in which fluid is transported.

The outer surface 2b of the fluid-tight polymer sheath 2 will suitably be surrounded by a not shown pressure armor and/or tensile armor.

FIG. 2 shows an alternative embodiment of the layered internal pressure sheath 1. In this embodiment the internal pressure sheath 1 also comprises a fluid-tight polymer sheath 2, a barrier layer 3 and a permeable protection sheath 4.

In this embodiment the barrier layer 3 is applied as a tape 6, which has been wound to a tubular shape which fits with the inner surface 2a of the fluid-tight polymer sheath 2. The tape 6 is wound so the windings have an inclination in respect of the longitudinal direction 8 of the internal pressure sheath. The tape 6 is bonded with the outer surface 3b to the inner surface 2a of the fluid-tight polymer sheath 2. The tape 6 is wound in such a way so a gap 7 is provided between each of the windings of the tape.

FIG. 3 shows further details of the layered internal pressure sheath 1. The fluid-tight polymer sheath 2 has a barrier layer 3 bonded to the inner surface 2a. Adjacent to the inner surface 3a of the barrier layer 3 is the permeable protection sheath 4. In this embodiment the internal pressure sheath 1 is reinforced with a carcass 9 located on the inner surface 4a of the permeable protection sheath 4.

The permeable protection sheath 4 comprises holes 10 through which a fluid, such as a gas, may penetrate through the permeable protection sheath and come into contact with the barrier layer 3, which in this embodiment is in the form of a wound tape 6.

FIGS. 4A and B show a section of a permable polymer sheath 4 according to the invention. FIG. 4A shows a cross section of the permeable protection sheath 4 and FIG. 4B shows a part of the permeable protection sheath 4 seen towards the surface 4a.

In the cross section of FIG. 4A the permeable protection sheath 4 is seen with a hole 10 which passes through the permeable protection sheath 4 from the inner surface 4a to the outer surface 4b. As previously explained the inner surface 4a is facing the bore and is in contact with a carcass and the outer surface 4b is facing the barrier layer (in this figure the carcass and the barrier layer are not shown). The hole 10 is reinforced with a metal ring 11, which may be a bush.

In FIG. 4B the hole 10 is seen from the surface 4a of the permeable protection sheath 4 where the ring shaped metal bush 11 is also seen. The reinforcement 11 serves to prevent the polymer material in the permeable protection sheath 4 from flowing and blocking the hole 10.

FIG. 5 shows an embodiment of the permeable protection sheath 4. The permeable protection sheath 4 comprises a pattern of holes 10 distributed in the sheath. Each hole 10 passes through the permeable protection sheath from the inner surface 4a to the outer surface 4b.

FIG. 6 shows an embodiment in which the permeable protection sheath 4 comprises indentations 12. The indentations 12 have the effect that the fluid-tight polymer sheath 2 with the barrier layer 3 bonded thereto will form a bulge 13 which will penetrate into the indentation 12. In this way the permeable protection sheath 4 will be locked in respect of the barrier layer 3 and the fluid-tight polymer sheath 2, and axial displacement of the permeable protection sheath 4 is inhibited. The indention 12 may continue around the permeable protection sheath 4 thereby forming an annular groove in the permeable protection sheath.

In this embodiment the barrier layer 3 is applied as a tape 6 wound with overlapping sections 14.

What is claimed is:

1-18. (canceled)

19. An unbonded flexible pipe having a longitudinal axis and a bore for transport of a fluid, said unbonded flexible pipe comprises one or more external armouring layers wound around an internal pressure structure defining the bore, said internal pressure structure comprises from the inside and out a permeable protection sheath, a barrier layer and a fluid-tight polymer sheath, wherein the barrier layer is bonded to the fluid-tight polymer sheath.

20. An unbonded flexible pipe according to claim 19, wherein the barrier layer is bonded to the inner surface of the fluid-tight polymer sheath by means of physical or chemical bonding.

21. An unbonded flexible pipe according to claim 19, wherein the bonding is a coherent bonding.

22. An unbonded flexible pipe according to claim 19, wherein the barrier layer at least covers a part of the inner surface of the impermeable protection sheath.

23. An unbonded flexible pipe according to claim 19, wherein the barrier layer is an elongate strip or tape.

24. An unbonded flexible pipe according to claim 19, wherein the barrier layer is an elongate strip or tape wound with windings to form a tubular structure.

25. An unbonded flexible pipe according to claim 19, wherein the barrier layer is an elongate strip or tape wound with windings to form a tubular structure and wherein the there is an overlap between adjacent windings.

26. An unbonded flexible pipe according to claim 19, wherein the barrier layer is an elongate strip or tape wound with windings to form a tubular structure and wherein there is a distance d between the adjacent windings.

27. An unbonded flexible pipe according to claim 19, wherein the barrier layer is selected from a metal foil, a polymer film, a ceramic film, or a combination of two or more of these.

28. An unbonded flexible pipe according to claim 19, wherein the barrier layer has a thickness which is less than 1 mm.

29. An unbonded flexible pipe according to claim 19, wherein the barrier layer is a single layer.

30. An unbonded flexible pipe according to claim 19, wherein the permeability coefficient of the barrier layer is at least 10 times lower than the permeability coefficient of the fluid-tight layer.

31. An unbonded flexible pipe according to claim 19, wherein the permeable protection sheath is porous.

32. An unbonded flexible pipe according to claim 19, wherein the permeable protection sheath comprises holes.

33. An unbonded flexible pipe according to claim 19, wherein the permeable protection sheath comprises holes and wherein the holes in the permeable protection sheath are reinforced.

34. An unbonded flexible pipe according to claim 19, wherein the permeable protection sheath in the surface facing the metal layer comprises one or more indentations.

35. An unbonded flexible pipe according to claim 19, wherein the permeable protection layer has a permeability coefficient which is at least 10 times higher than the permeability coefficient of the fluid-tight layer.

36. An unbonded flexible pipe according to claim 19, wherein the unbonded flexible pipe comprises a carcass.
